(19) United States
(12) Patent Application Publication
(10) Pub. No.: US 2024/0403694 A1
(43) Pub. Date: Dec. 5, 2024

(54) GROUP RECOMMENDATION BASED ON TOPIC CLUSTERING

(71) Applicant: Microsoft Technology Licensing, LLC, Redmond, WA (US)

(72) Inventors: Yashu Seth, Patna (IN); Franklin Geo Francis, Bangalore (IN); Uma Kamlakar Sawant, Bangalore (IN); Nikhil N. Jannu, Bangalore (IN)

(21) Appl. No.: 18/203,888

(22) Filed: May 31, 2023

(51) Int. Cl. G06N 20/00

(52) U.S. Cl. CPC G06N 20/00

(57) ABSTRACT

Methods, systems, and computer programs are presented for determining when to recommend posting in a group and joining a group. One method includes clustering posts by associating a topic identifier with each post based on the post text, and mapping each of the groups to one of the topic identifiers based on topics associated with the posts. A topic-to-group table, mapping each of the topic identifiers to one or more of the groups, is created, and a post classifier model is trained with the posts text and the topic identifiers. When an additional post is entered, the model determines a topic identifier for the additional post based on text of the additional post, and a group recommendation is determined for posting the additional post based on the topic identifier for the additional post and the table. The group recommendation is presented for posting the additional post in the recommended group.

The subject matter disclosed herein generally relates to methods, systems, and machine-readable storage media for detecting when a user adds content to an online service, analyzing the content, and recommending a space for posting the user-generated content.

### BACKGROUND

Social networks sometimes provide special areas where people with the same interest can communicate, such as groups, communities, clusters, etc. For example, in a professional social network, groups are community-oriented places where like-minded professionals on the platform share similar interests, connect, brainstorm, and collaborate on mutual topics of interest.

The social networks wish to have high traffic in these groups because high traffic generates more user engagement. Additionally, more traffic in the groups improves their value to the community as members learn from others with similar interests. However, sometimes the traffic in these groups is low when compared to the amount of traffic generated by users posting on their own feed. Traffic in groups may also be low due to lack of awareness and discovery challenges for these communities, lack of awareness because users may not know that social networks offer these community-oriented features, and discovery because users often have difficulty finding communities that match their interests.

Since typically users create content for groups, it is difficult to increase group traffic without the cooperation of users. Thus, ways to increase group traffic are needed to increase user engagement.

### BRIEF DESCRIPTION OF THE DRAWINGS

The appended drawings merely illustrate example embodiments of the present disclosure and cannot be considered as limiting its scope.

FIG. 1 illustrates a screenshot of a user page, according to some example embodiments.

FIG. 2 is a User Interface (UI) for creating a post by the user, according to some example embodiments.

FIG. 3 is a UI for a suggestion, presented to the posting user, to add the post to a group, according to some example embodiments.

FIG. 4 is a UI showing a group feed, according to some example embodiments.

FIG. 5 illustrates the clustering of post topics for two different techniques, according to some example embodiments.

FIG. 6 is a flowchart of a method for creating mappings of topics to groups, according to some example embodiments.

FIG. 7 is a flowchart of a method for training a post classifier, according to some example embodiments.

FIG. 8 illustrates the process for recommending a group when the user adds a new post.

FIG. 9 illustrates the architecture for generating the group recommendation, according to some example embodiments.

FIG. 10 is a flowchart of a method for determining when to recommend posting in a group, according to some example embodiments.

FIG. 11 is a block diagram illustrating a networked architecture, according to some example embodiments.

FIG. 12 illustrates the training and use of a machine-learning model, according to some example embodiments.

FIG. 13 is a flowchart of a method for determining when to recommend posting in a group and when to join a group, according to some example embodiments.

FIG. 14 is a block diagram illustrating an example of a machine upon or by which one or more example process embodiments described herein may be implemented or controlled.

### DETAILED DESCRIPTION

Example methods, systems, and computer programs are directed to determine when to recommend posting in a group and joining a group. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

One objective of the presented embodiments is to make real-time group recommendations on an online service that includes user groups. This may be challenging when the number of groups is high, such as more than 100K, and because there are many overlaps between groups in terms of the group topic. For example, an online service may have more than 15 groups on the topic of “Machine Learning.” To accomplish this objective, three operations are utilized:

First, the content embeddings of group posts are clustered using dimensionality reduction and a hierarchical clustering to identify topic clusters. This includes learning a frequency-based relationship (mapping of topic to group) between the generated topic clusters and the groups from the training data used to train the clustering model.

Second, the system predicts topic clusters. Using the topic-to-group mapping previously obtained, a list of relevant groups can be generated for the new post. This approach allows for accurate recommendations, as it accounts for the overlap in topics and interests between groups.

Third, a separate simpler classifier is trained directly on the topic clusters generated before to overcome the latency constraint in real-time applications, because embedding models are generally inadequate for online inference or may consume too many computing resources in a busy system. This simpler classifier is optimized for real-time inference, allowing for fast group recommendations in real time.

One general aspect includes a computer-implemented method that includes an operation for clustering posts by associating a topic identifier with each post based on text in the post, the posts having been posted in groups associated with an online service. The method further includes mapping each of the groups to one of the topic identifiers based on topics associated with the posts, creating a topic-to-group table mapping each of the topic identifiers to one or more of the groups, and training a post classifier model with a training set comprising the text of the posts and the topic identifier associated with each post. Further, the method includes detecting an additional post entered by a user associated with the online service, determining, by the post classifier model, a topic identifier for the additional post based on text of the additional post, and determining a group recommendation for posting the additional post based on the topic identifier for the additional post and the topic-to-group table. The method further includes causing presentation, based on the determining, of the group recommendation to the user for posting the additional post in the recommended group.

For the purposes of this description the phrases “an online social networking application” and “an online social network system” may be referred to as and used interchangeably with the phrases “an online system,” “an online service,” “a networked system,” or merely “a connections network.” It will also be noted that a connections network may be any type of an online network, such as, a professional network, an interest-based network, or any online networking system that permits users to join as registered members. For the purposes of this description, registered members of a connections network may be referred to as simply members or users, and some un-registered users may also access the services provided by the online service. As used herein, a “user” refers to any person accessing the service, either registered or unregistered. Further, some connections networks provide services to their members (e.g., search for jobs, search for candidates for jobs, job postings) without being a social network, and the principles presented herein may also be applied to these connection networks.

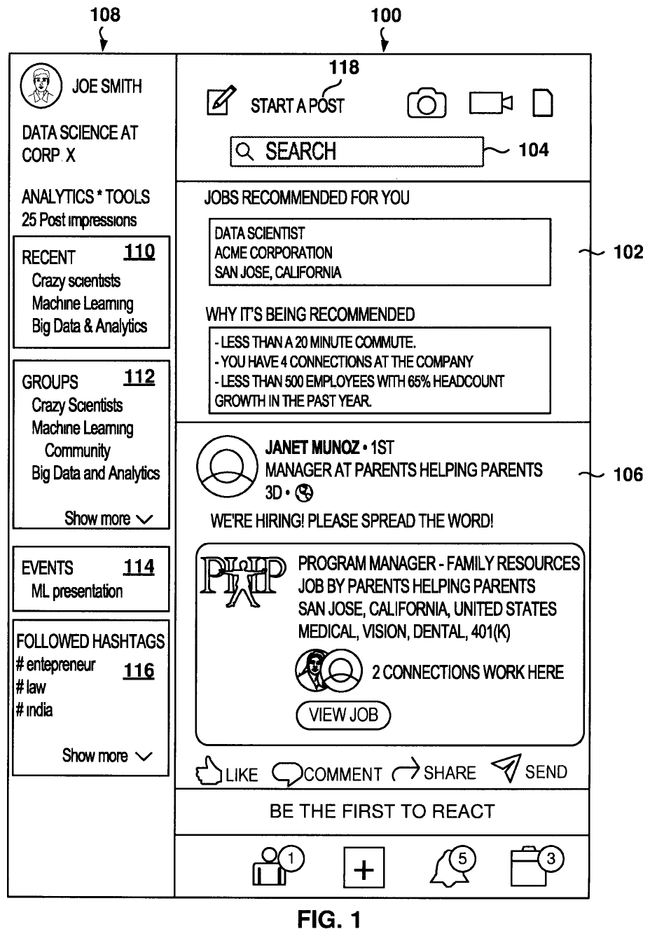

FIG. 1 illustrates a screenshot of a user page, according to some example embodiments. In the illustrated example, the user, named Joe Smith, may be a creator of content or a viewer of content generated by other users.

The user page includes a user feed 100 and a user area 108. The user feed 100 can include various categories such as a search field 104, job recommendations 102, notifications, content item 106, sponsored items, shortcuts, news, messages, articles, and the like. The content item 106 can be published or posted on the user feed 100 to be viewed by the user. Further, an option 118 is provided to start a post. After the user completes the post, the post is presented to connections of the user or is made public for the whole community to access.

In one example embodiment, a network service user interface provides the job recommendations 102 that match job interests of a member and that are presented without a specific job search request from the member, referred to herein as “jobs you may be interested in” (JYMBII). With the job recommendation 102, reasons why the job is being recommended can be included in a recommendation feature portion.

In another example embodiment, the user feed 100 includes suggestions or recommendations (not shown) for adding new connections (e.g., People You May Know [PYMK]). Similar to the job recommendation, the connection recommendation can include a recommendation feature portion that indicates reasons (e.g., features) why the connection recommendation was made, whereby the features are obtained from a rule list generated from a connection recommendation tree ensemble.

Similar recommendation feature portions can be provided for other recommendations presented by the networking server such as hashtag recommendations, follow recommendations, company recommendations, and so forth. Each of these recommendation feature portions can include features identified from a corresponding rule list generated from a corresponding tree ensemble. The user can engage with the content item 106 by “liking”, commenting, sharing, sending the content item 106, and the like.

The user area 108 includes information about the user (e.g., name, picture, title), recent activity 110, groups 112, events 114, and followed hashtags 116. The groups 112 area includes information about the groups that the user belongs to, and the events 114 area provides information about events that the user is attending or may attend. Further, the hashtags 116 area provides a list of hashtags followed by the user.

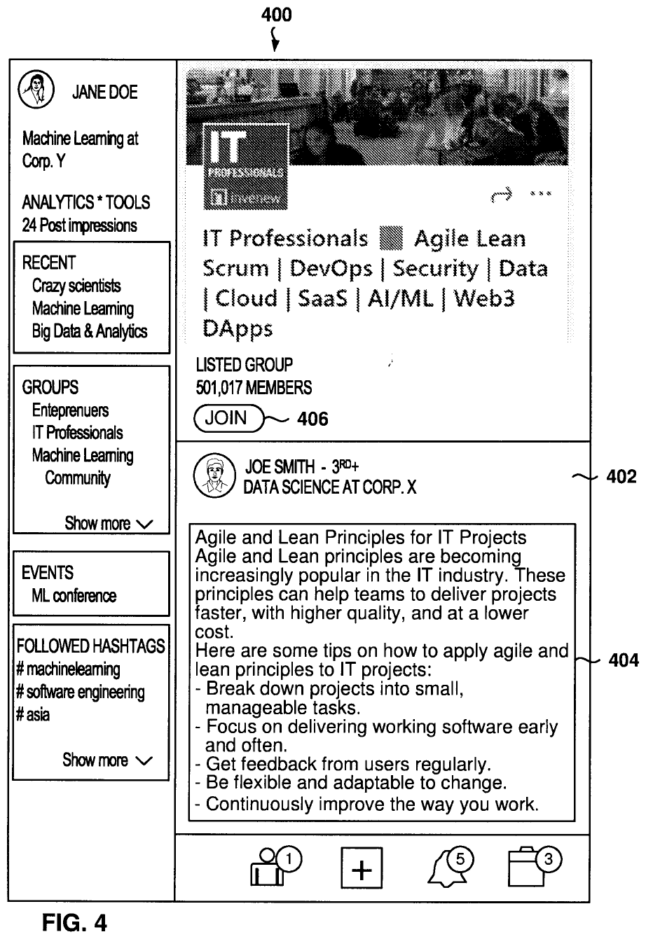

When the user selects a group, a group feed is presented with information about the group, such as the group feed illustrated in FIG. 4. The group feed is similar to the user feed 100 but contains items related to the topic of the group. Some groups may be open to anyone, while other groups contain one or more moderators that control who can join the group. Further, the items posted to the group may be configured to be viewed by the group members only or open to all members of the online service. Additionally, an automated member approval is available for some groups that are configured to allow anyone to join without requiring express approval.

Groups provide the users with access to vetted professionals that may not be in the users' network for access to knowledge on niche topics. Users may access groups for several reasons, such as wanting to discuss and troubleshoot problems with other group members (knowledge seekers) and wanting to increase the reputation and be perceived as knowledgeable, approachable, and supportive for giving career advice (knowledge creators).

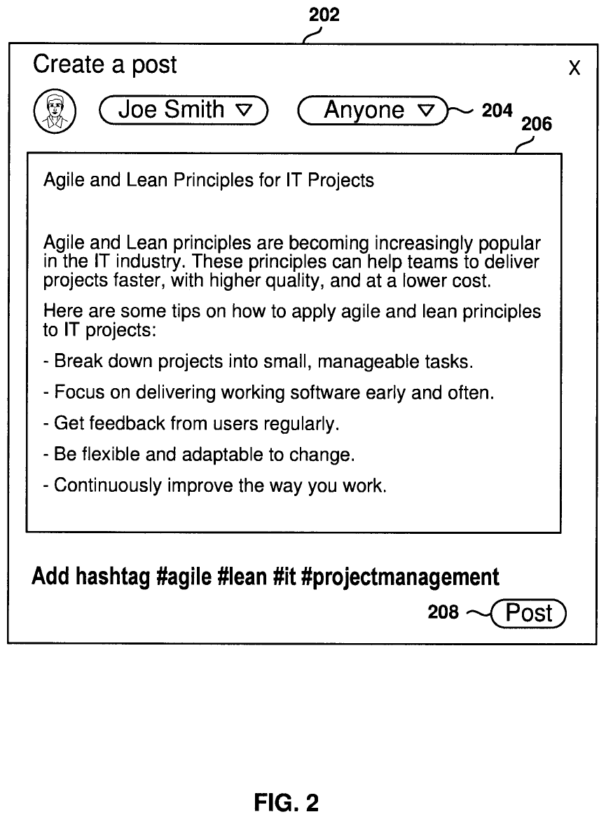

FIG. 2 is a User Interface (UI) 202 for creating a post by the user, according to some example embodiments. After the user selects the option 118 to start a post in the user feed, the UI 202 is presented. The user may fill in the content of the post in field 206, but other options are available to include other type of media, such as an image, a video, or a link to a webpage.

By selecting option 204, the user may make the post available to anyone in the online service or just to connections of the user. Additionally, hashtags can be suggested at the bottom to be included in the post. When the user selects the post option 208, the post is published on the online service.

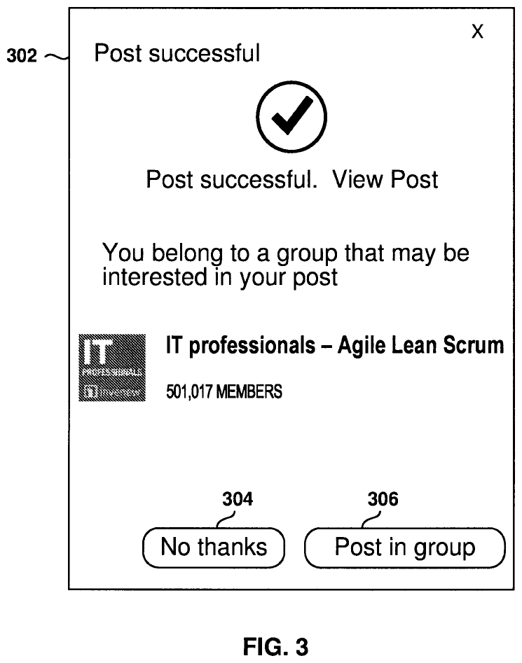

FIG. 3 is a UI 302 for a suggestion, presented to the posting user, to add the post to a group, according to some example embodiments. On a given week, there could be millions of users adding content to their feeds; however, only a few thousand members may be adding content to groups, which shows the relatively low content liquidity that is being added to the groups. The content is being distributed only within the users' networks, but the content is not being circulated within the communities that the users have joined, even though much of the content created would be relevant to some groups. For example, in one network, about 0.3% of the members of a group create content for the groups, while about 17% of these group members create content for their own user feeds. During some experiments, about 20% of such content created on the user's own feed was identified to be relevant to the groups where the authors were members.

One potential reason for the lack of traffic in groups could be that users are not joining groups, but evidence shows that this is not true because many users are already members of groups and access groups frequently.

One way to add traffic to groups is to raise awareness among users that the content they are creating could be a good post to place on a group. One perfect moment to raise awareness is when the user creates the post. In some example embodiments, the user is presented with a suggestion to let the user know that the content would be a good candidate for posting in a group, right after noting that the post was successful.

In some example embodiments, the user is presented with the suggestion right after selecting the button to create the post. In other embodiments, suggestions may also be presented while the user is creating the post. In the illustrated example, the user is offered a suggestion for one group (named IT professionals-Agile Lean Scrum), but other embodiments may offer more than one suggestion.

The user is provided with option 304 to ignore the suggestion and option 306 to accept the suggestion and post the content in the suggested group. If the user selects option 306, the post will be added to the group feed of the suggested group. In some example embodiments, a UI is provided to the user for editing the post if desired, before adding the post to the group. This UI is similar to the UI of FIG. 2, with an editing window and a post button, and when the user selects the post button, the content is posted on the feed of the group.

A good time to make the suggestion to post in the group is right after the user creates the post because the subject matter is fresh in the user's mind and the content creator has shown the intent to share the content with the group. Sending other communications and waiting for a response always results in lower acceptance ratios.

However, for the suggestion to be effective the recommendation has to be for a group with a topic related to the topic of the post; otherwise, the user may be confused or show displeasure with a bad suggestion. Thus, the challenges are to generate a recommendation quickly and for the most relevant group for the created post.

Automatically detecting when a post is appropriate for a group is a technical challenge given the large amount of groups and types of content that can be created. Additionally, it requires understanding of the subject matter of the post, which is a complicated problem for computer systems. The posts can have thousands of different topics to choose from and a single post can be related to multiple topics, e.g., the post, “#Artificial intelligence (AI) has had a significant impact on the #pharmaceuticalindustry and has the potential to revolutionize the way drugs are discovered, developed, and delivered to patients,” is relevant to both the topics Artificial Intelligence (Technology), and Pharmaceutics (Health).

Topics can be very diverse, like “Machine Learning” and “Public Services,” and be related to other topics, e.g., Machine Learning is related to, and is a subset of, Artificial Intelligence. Further, the group title and description, comprising a few words or sentences, are often not enough for a machine to capture the full extent of group topics; hence an alternate, scalable, and reliable data-based approach to decipher group topics is required. For example, a group with the title of “Sticky Branding,” and the description “The Sticky Branding Group is for anyone interested in growing a Sticky Brand, may be difficult to obtain topics for given the little information known about the group.

Further, some content within groups can also be spam or irrelevant to the group topic and can lead to incorrect tagging of group topics. Apart from understanding of the subject matter of the post and groups, identifying the relevant group for a content is also challenging for a machine. In some scenarios, the post and group may relate to the same topics, but the intent behind the post may be against group rules of posting personal updates. For example, a post about the author announcing their new job in a DevOps role to their immediate network may not be a suitable post for a DevOps group that does not welcome such personal updates.

Additionally, a post may be partially or broadly relevant to a group topic but still not suitable for a recommendation. For example, a post about the latest smartphone (topics: Technology, Mobile Devices) may not be relevant for a Data Science group (topics: Technology, Artificial Intelligence, Machine Learning). A high confidence in the relevance between the post and group is required to ensure an optimal experience for the content author, and the users in the group.

Further, being able to make a recommendation immediately after the user posts to the user's feed is technically challenging because the computer system needs to quickly analyze the content and intent of the post and explore the different groups where this content could be posted, all this being performed in the order of a hundred milliseconds.

Adding content to groups can be very beneficial to the user, as it increases the exposure of the user on the online service, and more importantly, within a group of cohorts with a shared interest in a given topic. This expands the potential audience of the post to a larger number of users. Also, as the number of posts to the group increase, so will increase the engagement of group members, as the number of members in a group is typically between a few thousands and up to a few million.

In some embodiments, a suggestion to join a group may be presented to the user. For example, if the system identifies an adequate group for the post and the user is not a member of the group, then a UI may be presented asking the user to join the identified group.

FIG. 4 is a UI 400 showing a group feed, according to some example embodiments. If the user requests to add a post to the group (e.g., after accepting the suggestion presented in FIG. 3), then the post is added to the group.

In the illustrated example, post 402 has been added by a user (e.g., Joe Smith), with the post text 404, and this post will be presented to the members of the group. If the group is open to other members, the post may also be presented to non-group members. An option 406 may be included to request being added to the group.

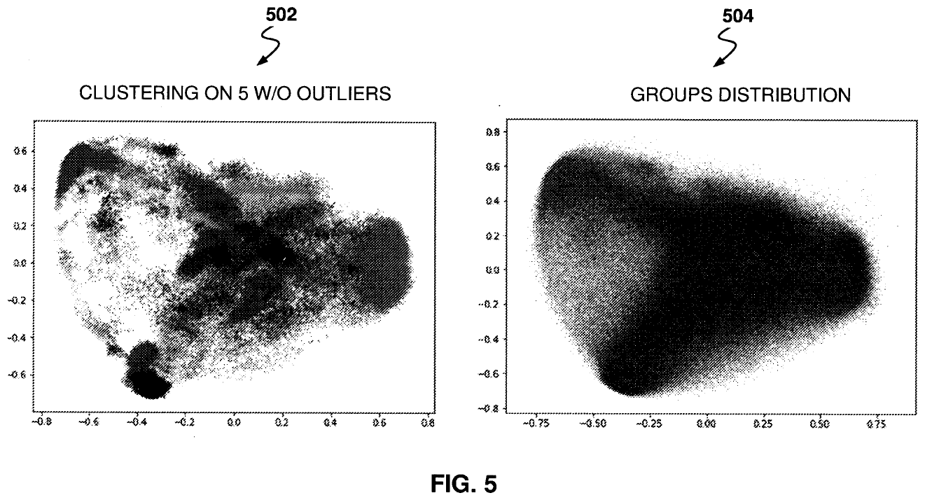

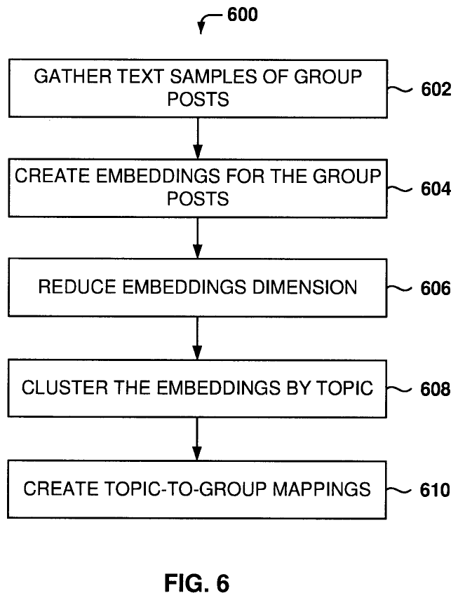

FIG. 5 illustrates the clustering of post topics for two different techniques, according to some example embodiments. As discussed in more detail below with reference to FIG. 6, clustering of posts is used to identify clusters of topics, where a cluster refers to a group of posts that refer to the same topic.

Before clustering, embeddings of the posts are created. An embedding is a vector that represents the post. The embeddings are created such that posts that refer to the same topic will have vectors that are close to each other; that is, the distance of the vectors in the multidimensional space associated with the vectors is below a predetermined threshold. In some example embodiments, an embedding model is used that creates vectors with a dimension of 50, but other dimensions may also be used.

However, clustering algorithms that operate on high-dimensional data do not usually perform well. To improve clustering, a technique is used to create new vectors with a smaller dimension. In some example embodiments, a technique called Uniform Manifold Approximation and Projection (UMAP) is used for dimensionality reduction, but other algorithms may be used. UMAP is a dimensionality reduction technique that can be used to visualize high-dimensional data. UMAP is based on the idea that high-dimensional data often lies on a low-dimensional manifold, and that this manifold can be approximated by a graph. UMAP then projects the data points onto this graph, and uses this graph to create a low-dimensional embedding of the data.

In some example embodiments, the 50-dimension vectors are reduced to a vector of dimension five, but other dimensions may be used. For representation purposes, the embeddings are reduced to a two-dimensional vector that can be used to chart the posts, as seen in charts 502 and 504.

Chart 502 represents the topic clusters of posts on a 2-dimensional plane, where each cluster has a different shading. It can be observed that there are clear representations of clusters. Chart 504 represents the group clusters of posts on a 2-dimensional plane, and it can be observed that group clustering directly is practically non-existent. The scatter plot of post distribution hints at the fact that most of the groups may not be directly separable using similarity matching. This shows how low-dimensional embeddings are better for clustering.

FIG. 6 is a flowchart of a method 600 for creating mappings of topics to groups, according to some example embodiments. While the various operations in this flowchart are presented and described sequentially, one of ordinary skill will appreciate that some or all of the operations may be executed in a different order, be combined or omitted, or be executed in parallel.

Embodiments provide real-time group recommendations and the techniques do not depend on manual labeling and training for topic prediction. Instead, the system creates its own topic ontology without the need for labeled training information by using automated clustering.

The solution addresses the challenge posed by the high number of groups on the online service, where groups often have significant overlap in terms of topics and interests. The solution includes clustering text embeddings to identify topic clusters and then predicting topic clusters during inference. Further, a separate classifier is created that is optimized for real-time inference, resulting in improved computational speed and reduced use of computer resources when compared to other solutions. The separate classifier is able to meet the latency constraint for real-time use cases.

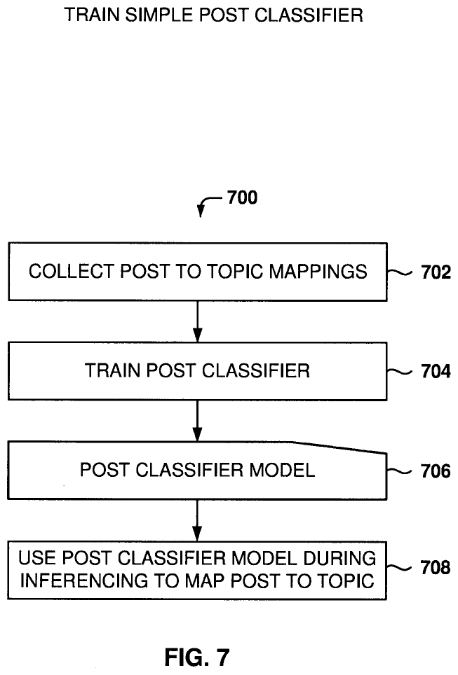

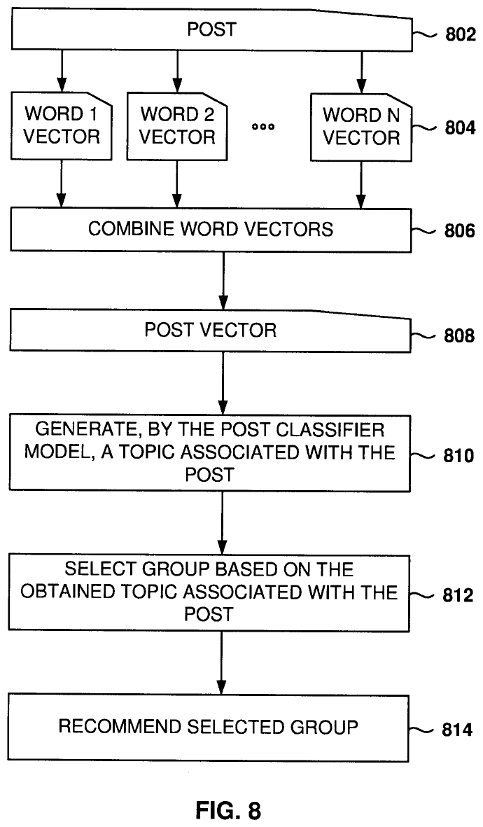

The technique for recommending groups includes three main operations. First, posts are clustered using training samples (e.g., existing group posts) that can represent topics to learn topic cluster-to-group mappings. Second, given a post text, the relevant cluster is predicted, as described in more detail below with reference to FIG. 7. Third, a group is recommended for a new post based on the topic cluster-to-group mapping, as described in more detail below with reference to FIG. 8.

At operation 602, the previously-posted group posts are gathered to create a training set. From operation 602, the method 600 flows to operation 604 to create embeddings for the group posts. In some example embodiments, the embeddings are 50-dimensional vectors, but other dimensions may be used.

From operation 604, the method 600 flows to operation 606 to create new embeddings with a reduced dimension. In some example embodiments, the new embeddings have a dimension of five, but other dimensions are also possible.

The objective is to group posts with similar topics in order to find relevant topics within the clusters. It is better to have embeddings with low dimensions, as many clustering algorithms struggle to deal with high dimensionality. In some example embodiments, UMAP is used for dimensionality reduction, but other embodiments may use other methods for dimensionality reduction, such as Principal Component Analysis (PCA). PCA is a dimensionality reduction technique that is used to reduce the number of features in a dataset while preserving as much of the variation in the data as possible. PCA works by finding a set of orthogonal (uncorrelated) directions that capture the most variation in the data. These directions are called Principal Components (PCs).

From operation 606, the method 600 flows to operation 608 to cluster the embeddings by topic. In some example embodiments, the HDBSCAN algorithm for clustering. HDBSCAN is a density-based clustering algorithm that is robust to noise and outliers. HDBSCAN is a hierarchical clustering algorithm that starts by finding core points, which are points that are surrounded by a certain number of other points. These core points are then used to grow clusters. HDBSCAN can find clusters of varying densities, and it is not sensitive to the choice of parameters. HDBSCAN is a good choice for clustering data that is not well-structured, and a good choice for clustering data that contains noise or outliers. HDBSCAN is not as fast as some other clustering algorithms, but it is more robust and can find more meaningful clusters.

In other embodiments, other clustering algorithms may be utilized, such as K-means. K-means groups data points into a predefined number of clusters. K-means works by iteratively assigning data points to the cluster with the closest mean, and then updating the cluster means based on the assigned data points. This process continues until the cluster assignments no longer change.

After the clustering, each post is associated with a topic identifier (ID) that represents the corresponding cluster. In some example embodiments, the topic ID is an integer but other embodiments may use vectors or real numbers.

It is noted that the clustering is performed based on the posts of the groups, but the clustering is not based in the group ID. That is, clustering is performed independently of the group ID of the posts. The number of topics used for clustering is tunable to have more or less topic clusters. In some example embodiments, the number of topics is 3000, but other cardinality of topics may be used.

From operation 608, the method 600 flows to operation 610 to create topic to group mappings. Once the mappings of post to topics are identified, the mappings of topic to group are learned based on the posts of the group. For example, the topic associated to each group corresponds to the topic that appears most often in the group posts. For example, one group has 80% of posts mapped to a particular topic ID, so this group would be mapped to this topic ID with an affinity of 80%, where the affinity is a value that measures how related a topic ID is to a group ID. The higher the affinity number, the higher correlation there is between group ID and topic ID.

The result is a table that maps each group (e.g., the group ID) to a topic ID. In some example embodiments, the group ID is an integer, where each group is associated with a different group ID. It is noted that the same topic ID may be associated with multiple group IDs. For example, all the groups that are associated with Artificial Intelligent may be mapped to the same topic ID for Artificial Intelligence.

FIG. 7 is a flowchart of a method 700 for training a post classifier, according to some example embodiments. While the various operations in this flowchart are presented and described sequentially, one of ordinary skill will appreciate that some or all of the operations may be executed in a different order, be combined or omitted, or be executed in parallel.

Once the topic clusters are identified, a post classifier model is trained to estimate the topic ID that corresponds to a new post. The advantage of having the post classifier model is that it consumes fewer resources than the clustering model, which means that the latency is less and allows responding in real time to recommend a group after the user creates a post. The post classifier model is a lightweight model (e.g., a shallow neural network) that is trained with the information obtained by the clustering model.

At operation 702, the mappings of post to topic are collected for the training of the post classifier model. From operation 702, the method 700 flows to operation 704 where the post classifier model is trained with the collected training data. The result of the training is the post classifier model 706. The post classifier model takes as an input the text of the post and produces as output the topic ID.

In some example embodiments the post classifier model is a FastText classifier, but other classifiers may be used, such as TextCNN, Bi-LSTM-based, and Log-Reg. FastText is a library for learning of word representations and text classification that supports supervised (classifications) and unsupervised (embedding) representations of words and sentences. FastText differs from other word embedding models in that it uses both n-grams and word vectors to represent words, allowing FastText to better represent rare words, which are often not represented well by word vectors alone. FastText uses a hierarchical softmax classifier, which reduces the computational complexity of training the model.

At operation 708, the post classifier model is used during inferencing to determine the topic ID associated with a post. Some topics can be manually labeled, and here are some examples of labels with their corresponding topic ID:
music_album_musicians_artists with topic ID of 0,
writing_writer_writers_write with topic ID of 6,
cybersecurity_cyber security_zero with topic ID of 11,
mental_health_depression_mentalhealth with topic ID of 8, and
java_programming_jvm_languages with topic ID of 18.

FIG. 8 illustrates the process for recommending a group when the user adds a new post. While the various operations in this flowchart are presented and described sequentially, one of ordinary skill will appreciate that some or all of the operations may be executed in a different order, be combined or omitted, or be executed in parallel.

To identify the group for a post 802, a word vector 804 (e.g., word 1 vector, word 2 vector, . . . word n vector) is generated for each word (e.g., word 1, word 2, . . . word n) of the post, and the word vectors 804 are combined at operation 806 to obtain the post vector 808.

In some example embodiments, the word vectors 804 are combined by obtaining the average of all the word vectors 804, but other embodiments may use other formulas to combine the word vectors 804.

FastText learns the dimensions of the vectors during training, and the vectors are smaller than the post vectors used by the clustering algorithm, that is, there is a compromise in precision to improve latency and provide a solution that works in real time in a busy system.

At operation 810, the post classifier model 706 generates the topic ID associated with the post 802.

From operation 810, the method flows to operation 812 to select the group ID based on the topic ID obtained at operation 810. As discussed above with reference to FIG. 6, the mappings of topics to groups was previously calculated and captured in a topic-to-group table, so once the topic ID is generated, the topic-to-group table is checked to obtain the relevant group that maps the topic.

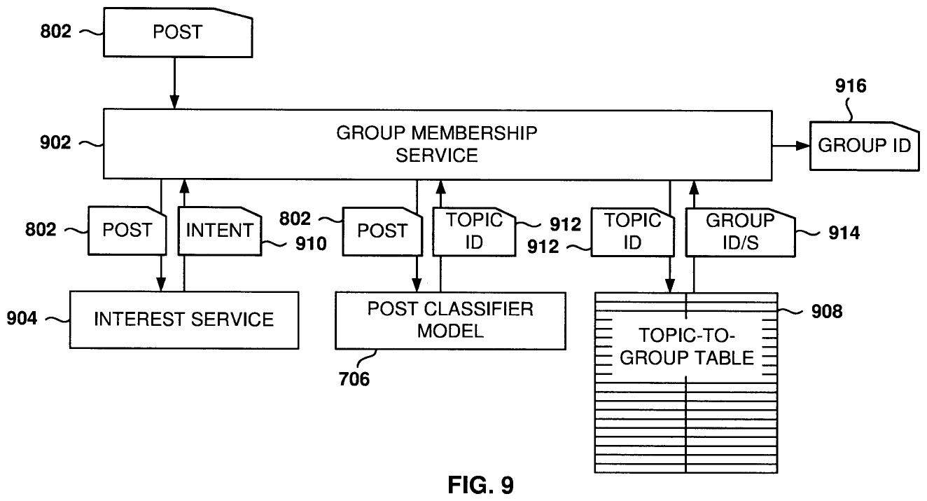

Since there may be overlap among the topics of the groups, the topic ID may match several groups and one of the groups is selected, as described in more detail below with reference to FIG. 9.

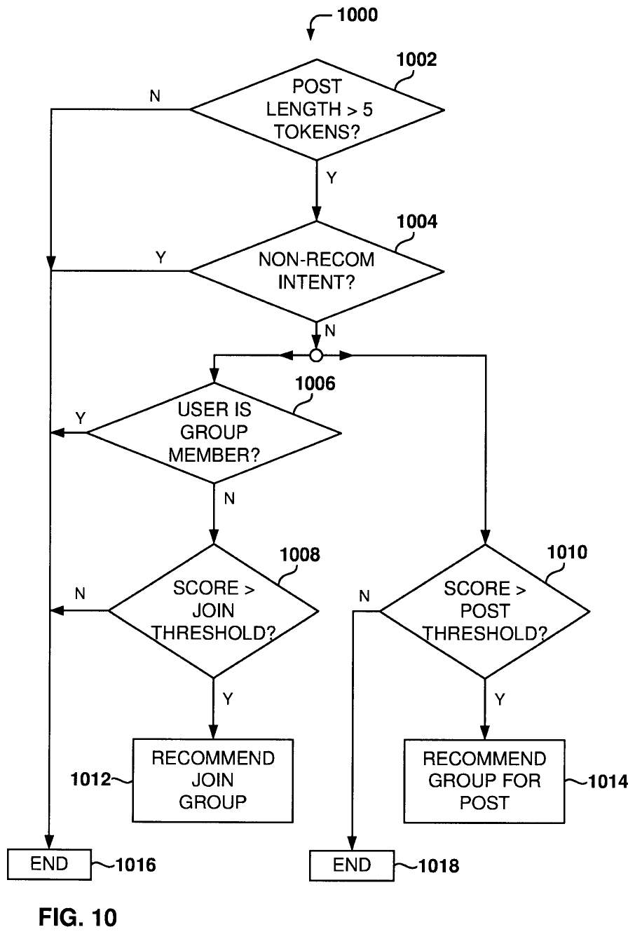

At operation 814, the selected group is recommended to the user if certain criteria are met, as described in more detail below with reference to FIG. 10.

FIG. 9 illustrates the architecture for generating the group recommendation, according to some example embodiments. When the user creates the post 802, the post is transferred to a group membership service 902.

The group membership service 902 performs one or more checks on the post to avoid recommending posts that are not of high interest or high relevance for the group, such as job-change announcements, congratulatory posts, or sales pitches. Some groups may be geared towards job opportunities, so job openings may be adequate for the group but not adequate for groups focused on information sharing.

The group membership service 902 calls an interest service 904 that returns the intent 910 to the group membership service 902. The intent is one from a plurality of predefined intents, such as information sharing, asking a question, promoting a user, promoting a business, congratulating someone, announcing a job opening, etc.

The group membership service 902 decides if the post is a good candidate for group recommendation or if the post should not be recommended, which would mean that the group membership service 902 would not provide a group recommendation. More details on filtering by intent are provided below with reference to FIG. 10.

The group membership service 902 determines the topic ID 912 of the post 802 by inputting the post 802 to the post classifier model 706, which returns the topic ID 912.

Once the group membership service 902 determines the topic ID 912, the group membership service 902 accesses the topic-to-group table 908 to determine one or more group IDs 914 that match the topic ID 912. As discussed above with reference to operation 610 of FIG. 6, the topic-to-group table 908 is a table that maps each group ID to a topic ID, and several group IDs may be mapped to the same topic ID. For example, all the groups that are associated with Software Development may be mapped to the same topic ID for Software Development. In some example embodiments, the group ID is an integer, where each group is associated with a different group ID.

If there is one group ID that matches the topic ID 912, the group membership service 902 uses that group ID as the output group ID 916 for the recommended group. If there are more than one group IDs, the group membership service 902 selects one of the group IDs to be the recommended group ID 916.

There could be different criteria to select one of the group IDs, such as selecting one at random, selecting the group ID that has the lowest traffic, selecting the group ID with the largest number of users, selecting the group ID with the most interactions from users, selecting in order the different group IDs, selecting randomly using a weighted distribution according to group size, etc., or any combination thereof.

FIG. 10 is a flowchart of a method 1000 for determining when to recommend posting in a group, according to some example embodiments. While the various operations in this flowchart are presented and described sequentially, one of ordinary skill will appreciate that some or all of the operations may be executed in a different order, be combined or omitted, or be executed in parallel.

It would not be a good recommendation to recommend a short post, such as a video or an image, so at operation 1002, the length of the post is checked. If the post has more than five words, the method 1000 flows to operation 1004; otherwise, the method 1000 ends at operation 1016 without recommending a group or asking the posting user to join the recommended group.

At operation 1004, the intent of the post is checked. In some example embodiments, congratulatory posts are discarded from consideration to be recommended.

Some types of intent may be appropriate for some groups but not for others. For example, job-related posts may be appropriate for some groups focused on job seekers, but not for groups based on sharing technical information. Sharing personal updates may be appropriate for groups based on motivating users and personal growth, but not for technical groups.

To filter posts with inappropriate intents, threshold counts are used for some types of intent, such as seeking job opportunity, sharing a job opportunity, sharing a company update, sharing a company update, sharing an achievement, sharing a personal update, thinking another user, congratulating another user, promoting a product, and promoting a service. If the group has at least a threshold percentage (e.g., ten percent) of posts with that intent, then the post is a candidate for recommendation; otherwise, the post is filtered out and the method 1000 flows to operation 1016.

If the intent of the group is determined to be appropriate for recommending, then the method 1000 bifurcates into two threads, a first thread at operation 1006 for determining if a recommendation to join a group will be provided and a second thread at operation 1010 for determining if the post will be recommended to the group.

At operation 1006, a check is made to determine if the user that created the post is a member of the group being recommended for the post. If the user is already a member, the first thread ends at operation 1016, and if the user is not already a member, the first thread continues to operation 1008.

At operation 1008, a check is made to determine if a user-group score is above a predetermined threshold. The user-group score measures a similarity between the user profile and the topics of the group. By checking the user-group score, the system will not recommend groups that are not well fitted for the user.

If the user-group score is above the predetermined threshold, the first thread flows to operation 1012 to recommend to the user to join the group; otherwise, the first thread ends at operation 1016.

In the second thread, at operation 1010, a post score is checked to determine if the post will be recommended to be posted in the group. The post score measures the affinity between the post and the group, where, the higher the affinity, the better fit the post is to the group.

If the post score is above a post threshold then the method flows to operation 1014 to recommend the post for being posted in the selected group; otherwise, the second thread ends at operation 1018. For example, the post may be recommended for posting as shown in the UI 302 of FIG. 3.

During some experimentation, it was observed that the coverage of group recommendations doubled when compared to a previous approach, and that the recommendations provided had a high degree of relevance to the content and the creator. Further, the implementation showed a 68% site-wide impact on the number of group creators that received a response.

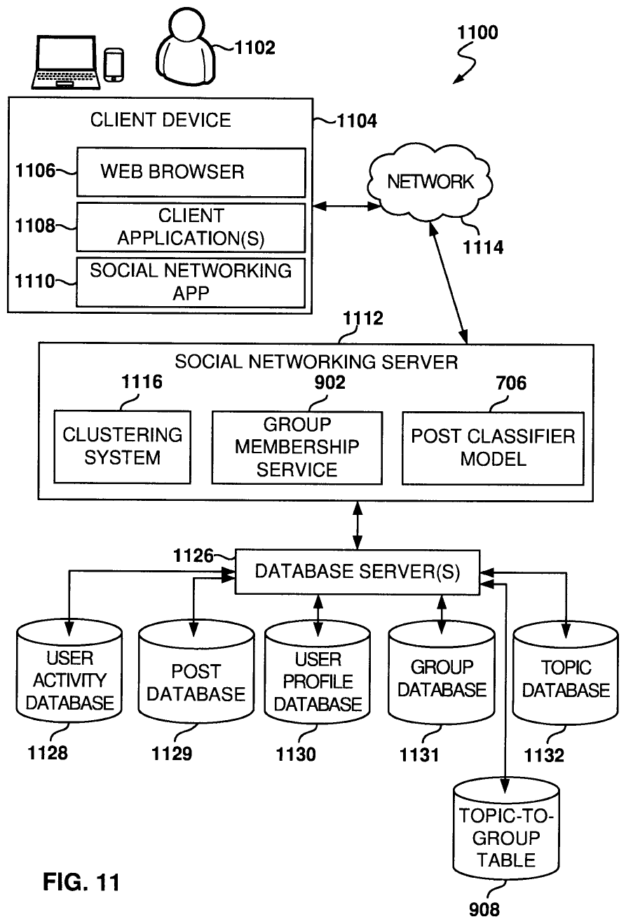

FIG. 11 is a block diagram illustrating a networked architecture 1100, according to some example embodiments. The networked architecture 1100 includes a networking server 1112, illustrating an example embodiment of a high-level client-server-based network architecture. Embodiments are presented with reference to an online service, and, in some example embodiments, the online service is a social networking service.

The social networking server 1112, a distributed system comprising one or more machines, provides server-side functionality via a network 1114 (e.g., the Internet or a wide area network [WAN]) to one or more client devices 1104. FIG. 11 illustrates, for example, a client device 1104 with a web browser 1106, client application(s) 1108, and a social networking app 1110 executing on the client device 1104. The social networking server 1112 is further communicatively coupled with one or more database servers 1126 that provide access to one or more databases 1128-1132.

The social networking server 1112 includes, among other modules, a clustering system 1116, the group membership service 902, and the post classifier model 706. The clustering system 1116 performs the clustering of the post topics.

The client device 1104 may comprise, but is not limited to, a mobile phone, a desktop computer, a laptop, a tablet, a netbook, a multi-processor system, a microprocessor-based or programmable consumer electronic system, or any other communication device that the user 1102 may utilize to access the social networking server 1112. In some embodiments, the client device 1104 may comprise a display module (not shown) to display information (e.g., in the form of user interfaces).

In one embodiment, the social networking server 1112 is a network-based appliance, or a distributed system with multiple machines, which responds to initialization requests or search queries from the client device 1104. One or more users 1102 may be a person, a machine, or other means of interacting with the client device 1104. In various embodiments, the user 1102 interacts with the networked architecture 1100 via the client device 1104 or another means.

In some embodiments, if the social networking app 1110 is present in the client device 1104, then the social networking app 1110 is configured to locally provide the user interface for the application and to communicate with the social networking server 1112, on an as-needed basis for data and/or processing capabilities not locally available (e.g., to access a user profile, to authenticate a user 1102, to identify or locate other connected users 1102, etc.). Conversely, if the social networking app 1110 is not included in the client device 1104, the client device 1104 may use the web browser 1106 to access the social networking server 1112.

In addition to the client device 1104, the social networking server 1112 communicates with the one or more database servers 1126 and databases. In one example embodiment, the social networking server 1112 is communicatively coupled to a user activity database 1128, a post database 1129, a user profile database 1130, a group database 1131, a topic database 1132, and the topic-to-group table 908.

The user activity database 1128 keeps track of the activities of the users in the online service, and the post database 1129 keeps information about the posts generated by users, including the posts added to groups. The user profile database 1130 keeps profile information about the users. The group database 1131 keeps information about the groups in the online service, and the topic database 1132 keeps topic information. The topic-to-group table 908 holds the mapping of group IDs to topic IDs and used by the social networking server 1112 to identify the groups that are related to a topic based on the topics in the posts of the respective groups.

In some example embodiments, when a user 1102 initially registers to become a user 1102 of the social networking service provided by the social networking server 1112, the user 1102 is prompted to provide some personal information, such as name, age (e.g., birth date), gender, interests, contact information, home town, address, spouse's and/or family users' names, educational background (e.g., schools, majors, matriculation and/or graduation dates, etc.), employment history (e.g., companies worked at, periods of employment for the respective jobs, job title), professional industry (also referred to herein simply as “industry.”), skills, professional organizations, and so on. This information is stored, for example, in the user profile database 1130. Similarly, when a representative of an organization initially registers the organization with the social networking service provided by the social networking server 1112, the representative may be prompted to provide certain information about the organization, such as a company industry.

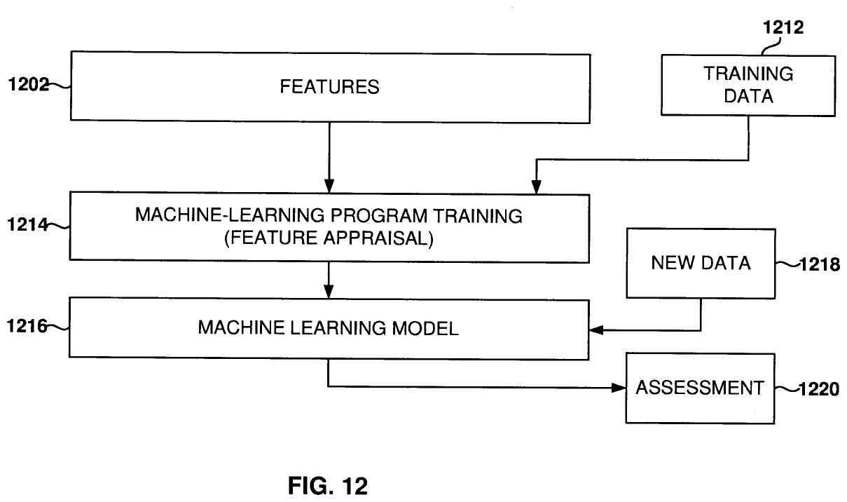

FIG. 12 illustrates the training and use of a machine-learning model, according to some example embodiments. In some example embodiments, machine-learning (ML) models 1216 are utilized to calculate the topic of a post.

Machine Learning (ML) is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Such machine-learning algorithms operate by building an ML model 1216 from example training data 1212 in order to make data-driven predictions or decisions expressed as outputs or assessments 1220. Although example embodiments are presented with respect to a few machine-learning tools, the principles presented herein may be applied to other machine-learning tools.

Data representation refers to the method of organizing the data for storage on a computer system, including the structure for the identified features and their values. In ML, it is typical to represent the data in vectors or matrices of two or more dimensions. When dealing with large amounts of data and many features, data representation is important so that the training is able to identify the correlations within the data.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm using information that is neither classified nor labeled, and allowing the algorithm to act on that information without guidance. Unsupervised ML is useful in exploratory analysis because it can automatically identify structure in data.

Common tasks for supervised ML are classification problems and regression problems. Classification problems, also referred to as categorization problems, aim at classifying items into one of several category values (for example, is this object an apple or an orange?). Regression algorithms aim at quantifying some items (for example, by providing a score to the value of some input). Some examples of commonly used supervised-ML algorithms are Logistic Regression (LR), Naive-Bayes, Random Forest (RF), neural networks (NN), deep neural networks (DNN), matrix factorization, and Support Vector Machines (SVM).

Some common tasks for unsupervised ML include clustering, representation learning, and density estimation. Some examples of commonly used unsupervised-ML algorithms are K-means clustering, principal component analysis, and autoencoders.

In some embodiments, example ML model 1216 create embeddings for text posts, cluster the embeddings of text post into topics, and estimate the topic for a post.

The training data 1212 comprises examples of values for the features 1202. In some example embodiments, the training data comprises labeled data with examples of values for the features 1202 and labels indicating the outcome, such as the topic associated with a post. The machine-learning algorithms utilize the training data 1212 to find correlations among identified features 1202 that affect the outcome. A feature 1202 is an individual measurable property of a phenomenon being observed. The concept of a feature is related to that of an explanatory variable used in statistical techniques such as linear regression. Choosing informative, discriminating, and independent features is important for effective operation of ML in pattern recognition, classification, and regression. Features may be of different types, such as, numeric, strings, categorical, and graph. A categorical feature is a feature that may be assigned a value from a plurality of predetermined possible values (e.g., this animal is a dog, a cat, or a bird).

In one example embodiment, the features 1202 may be of different types and may include one or more of words of the post, user profile information, and group information.

During training 1214, the ML program, also referred to as ML algorithm or ML tool, analyzes the training data 1212 based on identified features 1202 and configuration parameters defined for the training. The result of the training 1214 is the ML model 1216 that is capable of taking inputs to produce assessments.

The ML algorithms usually explore many possible functions and parameters before finding what the ML algorithms identify to be the best correlations within the data; therefore, training may make use of large amounts of computing resources and time.

When the ML model 1216 is used to perform an assessment, new data 1218 is provided as an input to the ML model 1216, and the ML model 1216 generates the assessment 1220 as output. For example, when a new post is detected, the ML model 1216 calculates the topic ID for the new post.

In some example embodiments, results obtained by the model 1216 during operation (e.g., assessment 1220 produced by the model in response to inputs) are used to improve the training data 1212, which is then used to generate a newer version of the model. Thus, a feedback loop is formed to use the results obtained by the model to improve the model.

Feature extraction is a process to reduce the amount of resources required to describe a large set of data. When performing analysis of complex data, one of the major problems is one that stems from the number of variables involved. Analysis with a large number of variables generally requires a large amount of memory and computational power, and it may cause a classification algorithm to overfit to training samples and generalize poorly to new samples. Feature extraction includes constructing combinations of variables to get around these large-data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or a similar, amount of information.

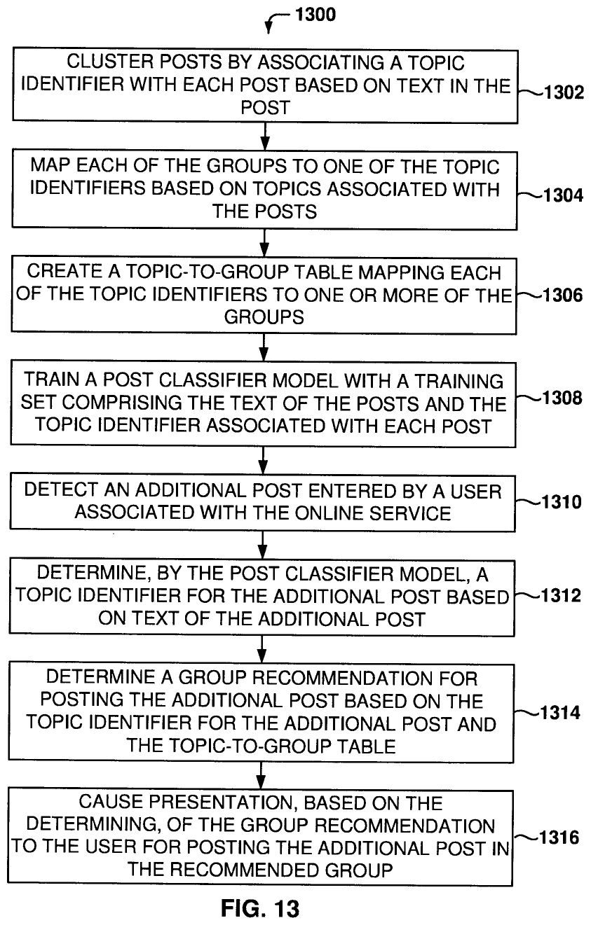

FIG. 13 is a flowchart of a method 1300 for determining when to recommend posting in a group and when to join a group, according to some example embodiments. While the various operations in this flowchart are presented and described sequentially, one of ordinary skill will appreciate that some or all of the operations may be executed in a different order, be combined or omitted, or be executed in parallel.

Operation 1302 is for clustering posts by associating a topic identifier with each post based on text in the post, the posts having been posted in groups associated with an online service.

From operation 1302, the method 1300 flows to operation 1304 to map each of the groups to one of the topic identifiers based on topics associated with the posts.

From operation 1304, the method 1300 flows to operation 1306 for creating a topic-to-group table mapping each of the topic identifiers to one or more of the groups.

From operation 1306, the method 1300 flows to operation 1308 for training a post classifier model with a training set comprising the text of the posts and the topic identifier associated with each post.

From operation 1308, the method 1300 flows to operation 1310 to detect an additional post entered by a user associated with the online service.

From operation 1310, the method 1300 flows to operation 1312 for determining, by the post classifier model, a topic identifier for the additional post based on text of the additional post.

From operation 1312, the method 1300 flows to operation 1314 for determining a group recommendation for posting the additional post based on the topic identifier for the additional post and the topic-to-group table.

From operation 1314, the method 1300 flows to operation 1316 for causing presentation, based on the determining, of the group recommendation to the user for posting the additional post in the recommended group.

In one example, the method 1300 further comprises determining if the user belongs to the recommended group, and causing presentation of a recommendation to the user to join the group when the user does not belong to the group.

In one example, clustering the posts further comprises: creating an embedding for each post, generating reduced embeddings for the posts with a smaller dimension from the created embeddings, and utilizing a clustering algorithm on the reduced embeddings to generate a plurality of topic identifiers.

In one example, determining the post classifier by the post classifier model enables generating the group recommendation in real-time or near real-time.

In one example, determining the group recommendation further comprises accessing the topic-to-group table to determine entries with the topic identifier.

In one example, determining the group recommendation further comprises determining that the topic identifier is mapped to several group identifiers, and selecting the recommended group at random from the several group identifiers.

In one example, determining the group recommendation further comprises determining an interest of the additional post, and filtering the group for being recommended based on the interest of the post.

In one example, filtering the group for being recommended further comprises determining a percentage of posts in the group associated with the determined interest, and determining that the group is recommended when the percentage of posts in the group is above a predetermined threshold.

In one example, the additional post is detected subsequent to the user adding the post to a user feed, wherein the group recommendation is presented in response to determining that the user added the post to the user feed.

In one example, the method 1300 further comprises posting the additional post in the recommended group after the user accepts the group recommendation.

Another general aspect is for a system that includes a memory comprising instructions and one or more computer processors. The instructions, when executed by the one or more computer processors, cause the one or more computer processors to perform operations comprising: clustering posts by associating a topic identifier with each post based on text in the post, the posts having been posted in groups of an online service; mapping each group to one of the topic identifiers based on topics associated with the posts in the group; creating a topic-to-group table mapping each topic identifier to one or more groups; training a post classifier model with a training set comprising the text of the posts and the topic identifier associated with each post; detecting an additional post entered by a user of the online service; determining, by the post classifier model, a topic identifier for the additional post based on text of the additional post; determining a group recommendation for posting the additional post based on the topic identifier for the additional post and the topic-to-group table; and causing presentation, based on the determining, of the group recommendation to the user for posting the additional post in the recommended group.

In yet another general aspect, a non-transitory machine-readable storage medium (e.g., a non-transitory storage medium) includes instructions that, when executed by a machine, cause the machine to perform operations comprising: clustering posts by associating a topic identifier with each post based on text in the post, the posts having been posted in groups of an online service; mapping each group to one of the topic identifiers based on topics associated with the posts in the group; creating a topic-to-group table mapping each topic identifier to one or more groups; training a post classifier model with a training set comprising the text of the posts and the topic identifier associated with each post; detecting an additional post entered by a user of the online service; determining, by the post classifier model, a topic identifier for the additional post based on text of the additional post; determining a group recommendation for posting the additional post based on the topic identifier for the additional post and the topic-to-group table; and causing presentation, based on the determining, of the group recommendation to the user for posting the additional post in the recommended group.

In view of the disclosure above, various examples are set forth below. It should be noted that one or more features of an example, taken in isolation or combination, should be considered within the disclosure of this application.

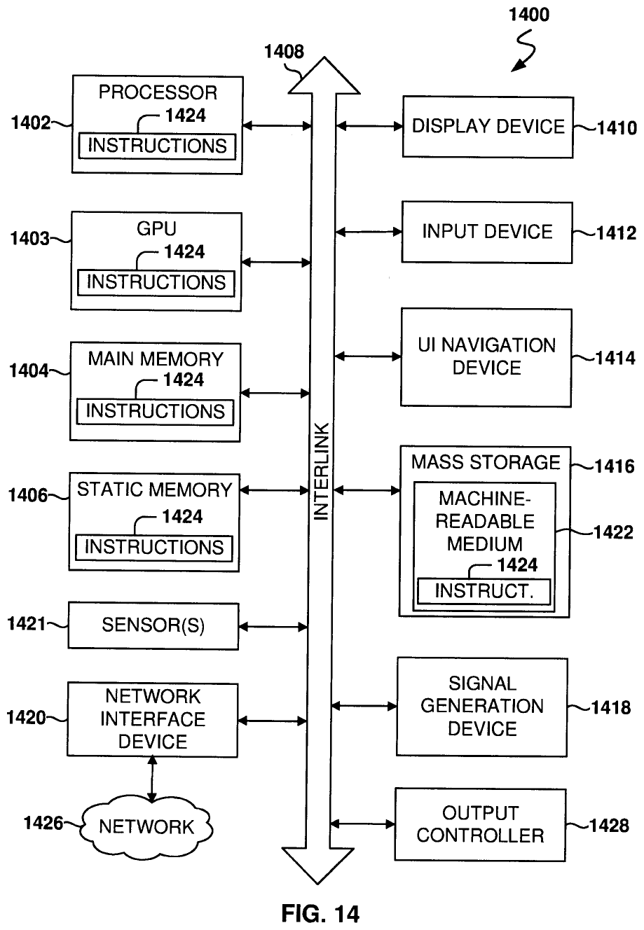

FIG. 14 is a block diagram illustrating an example of a machine 1400 upon or by which one or more example process embodiments described herein may be implemented or controlled. In alternative embodiments, the machine 1400 may operate as a standalone device or may be connected (e.g., networked) to other machines. In a networked deployment, the machine 1400 may operate in the capacity of a server machine, a client machine, or both in server-client network environments. In an example, the machine 1400 may act as a peer machine in a peer-to-peer (P2P) (or other distributed) network environment. Further, while only a single machine 1400 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, various components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine 1400 (e.g., computer system) may include a hardware processor 1402 (e.g., a central processing unit (CPU), a hardware processor core, or any combination thereof), a graphics processing unit (GPU 1403), a main memory 1404, and a static memory 1406, some or all of which may communicate with each other via an interlink 1408 (e.g., bus). The machine 1400 may further include a display device 1410, an alphanumeric input device 1412 (e.g., a keyboard), and a user interface (UI) navigation device 1414 (e.g., a mouse). In an example, the display device 1410, alphanumeric input device 1412, and UI navigation device 1414 may be a touch screen display. The machine 1400 may additionally include a mass storage device 1416 (e.g., drive unit), a signal generation device 1418 (e.g., a speaker), a network interface device 1420, and one or more sensors 1421, such as a Global Positioning System (GPS) sensor, compass, accelerometer, or another sensor. The machine 1400 may include an output controller 1428, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 1416 may include a machine-readable medium 1422 on which is stored one or more sets of data structures or instructions 1424 (e.g., software) embodying or utilized by any one or more of the techniques or functions described herein. The instructions 1424 may also reside, completely or at least partially, within the main memory 1404, within the static memory 1406, within the hardware processor 1402, or within the GPU 1403 during execution thereof by the machine 1400. In an example, one or any combination of the hardware processor 1402, the GPU 1403, the main memory 1404, the static memory 1406, or the mass storage device 1416 may constitute machine-readable media.

While the machine-readable medium 1422 is illustrated as a single medium, the term “machine-readable medium” may include a single medium, or multiple media, (e.g., a centralized or distributed database, and/or associated caches and servers) configured to store the one or more instructions 1424.

The term “machine-readable medium” may include any medium that is capable of storing, encoding, or carrying instructions 1424 for execution by the machine 1400 and that cause the machine 1400 to perform any one or more of the techniques of the present disclosure, or that is capable of storing, encoding, or carrying data structures used by or associated with such instructions 1424. Non-limiting machine-readable medium examples may include solid-state memories, and optical and magnetic media. In an example, a massed machine-readable medium comprises a machine-readable medium 1422 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1424 may further be transmitted or received over a communications network 1426 using a transmission medium via the network interface device 1420.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
clustering posts by associating a topic identifier with each post based on text in the post, the posts having been posted in groups associated with an online service;
mapping each of the groups to one of the topic identifiers based on topics associated with the posts;
creating a topic-to-group table mapping each of the topic identifiers to one or more of the groups;
training a post classifier model with a training set comprising the text of the posts and the topic identifier associated with each post;
detecting an additional post entered by a user associated with the online service;
determining, by the post classifier model, a topic identifier for the additional post based on text of the additional post;
determining a group recommendation for posting the additional post based on the topic identifier for the additional post and the topic-to-group table; and
causing presentation, based on the determining, of the group recommendation to the user for posting the additional post in the recommended group.

2. The method as recited in claim 1, further comprising:
determining if the user belongs to the recommended group; and
causing presentation of a recommendation to the user to join the group when the user does not belong to the group.

3. The method as recited in claim 1, wherein clustering the posts further comprises:
creating an embedding for each post;
generating reduced embeddings for the posts with a smaller dimension from the created embeddings; and
utilizing a clustering algorithm on the reduced embeddings to generate a plurality of topic identifiers.

4. The method as recited in claim 1, wherein determining the post classifier by the post classifier model enables generating the group recommendation in real-time or near real-time.

5. The method as recited in claim 1, wherein determining the group recommendation further comprises:
accessing the topic-to-group table to determine entries with the topic identifier.

6. The method as recited in claim 5, wherein determining the group recommendation further comprises:
determining that the topic identifier is mapped to several group identifiers; and
selecting the recommended group at random from the several group identifiers.

7. The method as recited in claim 1, wherein determining the group recommendation further comprises:
determining an interest of the additional post; and
filtering the group for being recommended based on the interest of the post.

8. The method as recited in claim 7, wherein filtering the group for being recommended further comprises:
determining a percentage of posts in the group associated with the determined interest; and
determining that the group is recommended when the percentage of posts in the group is above a predetermined threshold.

9. The method as recited in claim 1, wherein the additional post is detected subsequent to the user adding the post to a user feed, wherein the group recommendation is presented in response to determining that the user added the post to the user feed.

10. The method as recited in claim 1, further comprising:
posting the additional post in the recommended group after the user accepts the group recommendation.

11. A system comprising:
a memory comprising instructions; and
one or more computer processors, wherein the instructions, when executed by the one or more computer processors, cause the system to perform operations comprising:
clustering posts by associating a topic identifier with each post based on text in the post, the posts having been posted in groups associated with an online service;
mapping each of the groups to one of the topic identifiers based on topics associated with the posts;
creating a topic-to-group table mapping each of the topic identifiers to one or more of the groups;
training a post classifier model with a training set comprising the text of the posts and the topic identifier associated with each post;
detecting an additional post entered by a user associated with the online service;
determining, by the post classifier model, a topic identifier for the additional post based on text of the additional post;
determining a group recommendation for posting the additional post based on the topic identifier for the additional post and the topic-to-group table; and
causing presentation, based on the determining, of the group recommendation to the user for posting the additional post in the recommended group.

12. The system as recited in claim 11, wherein the instructions further cause the one or more computer processors to perform operations comprising:
determining if the user belongs to the recommended group; and
causing presentation of a recommendation to the user to join the group when the user does not belong to the group.

13. The system as recited in claim 11, wherein clustering the posts further comprises:
creating an embedding for each post;
generating reduced embeddings for the posts with a smaller dimension from the created embeddings; and
utilizing a clustering algorithm on the reduced embeddings to generate a plurality of topic identifiers.

14. The system as recited in claim 11, wherein determining the post classifier by the post classifier model enables generating the group recommendation in real-time or near real-time.

15. The system as recited in claim 11, wherein determining the group recommendation further comprises:
accessing the topic-to-group table to determine entries with the topic identifier.

16. A non-transitory machine-readable storage medium including instructions that, when executed by a machine, cause the machine to perform operations comprising:
clustering posts by associating a topic identifier with each post based on text in the post, the posts having been posted in groups associated with an online service;
mapping each of the groups to one of the topic identifiers based on topics associated with the posts;
creating a topic-to-group table mapping each of the topic identifiers to one or more of the groups;
training a post classifier model with a training set comprising the text of the posts and the topic identifier associated with each post;
detecting an additional post entered by a user associated with the online service;
determining, by the post classifier model, a topic identifier for the additional post based on text of the additional post;
determining a group recommendation for posting the additional post based on the topic identifier for the additional post and the topic-to-group table; and
causing presentation, based on the determining, of the group recommendation to the user for posting the additional post in the recommended group.

17. The non-transitory machine-readable storage medium as recited in claim 16, wherein the machine further performs operations comprising:
determining if the user belongs to the recommended group; and
causing presentation of a recommendation to the user to join the group when the user does not belong to the group.

18. The non-transitory machine-readable storage medium as recited in claim 16, wherein clustering the posts further comprises:
creating an embedding for each post;
generating reduced embeddings for the posts with a smaller dimension from the created embeddings; and
utilizing a clustering algorithm on the reduced embeddings to generate a plurality of topic identifiers.

19. The non-transitory machine-readable storage medium as recited in claim 16, wherein determining the post classifier by the post classifier model enables generating the group recommendation in real-time or near real-time.

20. The non-transitory machine-readable storage medium as recited in claim 16, wherein determining the group recommendation further comprises:
accessing the topic-to-group table to determine entries with the topic identifier.
